(19) United States
(12) Patent Application Publication
(10) Pub. No.: US 2020/0158214 A1
(43) Pub. Date: May 21, 2020

(54) ROTARY MACHINE

(71) Applicant: Hoe Jong Kim, River Edge, NJ (US)

(72) Inventor: Hoe Jong Kim, River Edge, NJ (US)

(21) Appl. No.: 16/550,417

(22) Filed: Aug. 26, 2019

Related U.S. Application Data
(60) Provisional application No. 62/769,737, filed on Nov. 20, 2018.

(51) Int. Cl. F16H 25/14; F16H 21/04; F16H 21/50

(52) U.S. Cl. CPC F16H 25/14; F16H 21/50; F16H 21/04

(57) ABSTRACT

A rotary machine includes a cam shaft; and a plurality of linkage shafts coupled to the cam shaft, each of the linkage shafts including a pair of identically-shaped first linkage members adapted for cam contact with the cam shaft, a pair of identically-shaped second linkage members pivotally coupled to the first linkage members, and a pair of identically-shaped third linkage members pivotally coupled to the second linkage members, wherein each of the linkage shafts is progressively and continuously changing between a shortest linkage state and a longest linkage state due to the cam contact between the cam shaft and the linkage shafts, upon rotation of the linkage shafts about the cam shaft.

### REFERENCE TO RELATED APPLICATIONS

This application claims the priority benefit of pending provisional U.S. Patent Application No. 62/769,737 filed on Nov. 20, 2018, the entire contents of which are incorporated herein by reference.

### FIELD OF THE INVENTION

The present invention relates to a rotary machine, and more particularly, to a rotary machine or rotating apparatus which utilizes the gravity and alternating centrifugal force to actuate the rotary motion of the apparatus.

### BACKGROUND OF THE INVENTION

An engine or motor is a device to convert one form of energy into mechanical energy. For example, electric motors convert electrical energy into mechanical motion, and internal combustion engines use hydraulic expansion energy of burning fuel in a combustion chamber to extract mechanical energy to drive a machine such as an automobile. For another example, windmills and waterwheels utilize the energy of wind and falling water, respectively, and convert such energy into a rotational motion of rotating arms of a wheel in order to generate electricity using the converted mechanical energy from the rotating arms.

Typically, the rotors or rotating arms of such rotary motion devices have constant lengths (i.e., arm radius) to provide reliable and continuous rotational motions in the apparatus, and such rotary motion devices uses low-frictional elements, such as bearings, adopted in the rotational components of the apparatus. However, there exists continuing needs to improve power efficiencies, structures and functions of such rotational apparatus. Moreover, it would be ideal to have such rotational apparatus resembling or emulating that of ideal motional devices that can rotate perpetually or in similar fashion, or with greater power efficiency while overcoming or cancelling the frictions existing in the mechanical components of the apparatus.

### SUMMARY OF THE INVENTION

The present invention has been made to solve the above-described concerns of improving the rotational power efficiencies and mechanical structures in the rotary machines or rotary motion devices.

In accordance with one aspect of the present invention, the rotary machine includes: a cam shaft; and a plurality of linkage shafts coupled to the cam shaft, each of the linkage shafts including a pair of symmetrically-shaped first linkage members adapted for cam contact with the cam shaft, a pair of symmetrically-shaped second linkage members pivotally coupled to the first linkage members, and a pair of symmetrically-shaped third linkage members pivotally coupled to the second linkage members, wherein each of the linkage shafts is progressively and continuously changing between a shortest linkage state and a longest linkage state in response to the cam contact between the cam shaft and the linkage shafts, upon rotation of the linkage shafts about the cam shaft.

The cam shaft of the rotary machine preferably includes a pair of stationary cam members, each cam member having a cam contact portion of relatively enlarged curve shape covering about one half of an outer circumference of the cam member, and a non-cam-contacting portion of reduced curve shape covering the remaining circumference of the cam member.

Each of the linkage shafts may further include a pair of symmetrically-shaped fourth linkage members pivotally coupled to the third linkage members. The rotary machine may further include at least one bearing retained in the first linkage members at an area for the cam contact with the cam shaft.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic representation of a portion of the rotary machine according to one embodiment of the present invention in the form of a mockup/prototype sample, for illustrating general concepts and basic operation of a linkage mechanism coupled to a cam shaft of the rotary machine, with only one linkage shaft shown from a plurality of linkage shafts for simplicity purposes;

FIG. 2 is another schematic representation of a portion of the rotary machine according to one embodiment of the present invention in the form of a mockup/prototype sample, for illustrating general concepts and basic operations of major operational members of the rotary machine, in which the machine includes multiple linkage shafts coupled to the cam shaft;

FIG. 3 is a photographic view illustrating exemplary shapes of the linkage shafts according to one embodiment of the present invention shown in the form of a mockup/prototype sample;

FIG. 4 is a photographic view showing the side views of the linkage shafts of FIG. 3, and further depicting the roller bearings retained in the base (i.e., first) linkage members of the linkage shafts;

FIG. 5 is a photographic view illustrating exemplary shapes of the cam members according to one embodiment of the present invention shown in the form of a mockup/prototype sample;

FIG. 6 is a photographic view showing the rear side of one of the exemplary cam members of FIG. 5;

FIG. 7 is a photographic view for illustrating the general concepts and basic operation of the linkage mechanism coupled to the cam shaft of the rotary machine shown in the form of a mockup/prototype sample, and more particularly, for depicting an operation state of the machine, that is, a shortened linkage state in which two adjacent linkage shafts rotating counterclockwise are shown to be in the vicinity of the starting point of the cam contact zone, with the linkage shafts shortened in overall length;

FIG. 8 is a photographic view for illustrating the general concepts and base operation of the linkage mechanism coupled to the cam shaft of the rotary machine, in particular, depicting an operation state (that is, an enlarged linkage state) of the machine, which is subsequent to the state shown in FIG. 7, in which the first linkage shaft (the left one in FIG. 7) rotating counterclockwise is located a distance away from the starting point of the cam contact zone, and relatively enlarged in the lengthwise direction while in contact with the cam surfaces of the cam shaft;

FIG. 9 is a photographic view for illustrating basic operations of the linkage mechanism of the rotary machine (shown in the form of a mockup/prototype sample) having two linkage shafts, where the cam members of the cam shaft are dissembled from the apparatus for simplicity purposes and in order to show the actual shapes of two linkage shafts in full detail;

FIGS. 10A, 10B and 10C are other photographic views for illustrating basic operations of the linkage mechanism coupled to the cam shaft of the rotary machine shown in the form of a mockup/prototype sample;

FIG. 11 is a photographic view similar to FIGS. 10A to 10C, illustrating further details of the linkage mechanism of the rotary machine shown in the form of a mockup/prototype sample, having two linkage shafts for example.

FIG. 12 is a drawing showing a major portion of the rotary machine according to another preferred embodiment of the present invention, for illustrating general concepts and basic operations of major operational members of the rotary machine, in which the machine includes three linkage shafts coupled to a cam shaft of the machine;

FIG. 13 is a drawing showing the construction of the combined structure of the linkage shaft and the guide shaft of the rotary machine according to the embodiment of FIG. 12;

FIG. 13A and FIG. 13B illustrate the reciprocating bar members of the machine of FIG. 12, in which FIG. 13A depicts the reciprocating bar of the first linkage shaft and FIG. 13B depicts the reciprocating bar of the second linkage shaft;

FIG. 14 illustrates the construction of the linkage shaft of the rotary machine according to the embodiment of FIG. 12;

FIG. 15 illustrates the construction of the cam member of the rotary machine according to the embodiment of FIG. 12; and

FIG. 16 illustrates possible applications and usage of the rotary machine.

### DETAILED DESCRIPTION OF THE INVENTION

Hereinafter, exemplary embodiments of the rotary motion apparatus according to the present invention will be described in detail with reference to the accompanying drawings.

However, the present invention may be modified in various forms, and therefore the present invention is not limited to the embodiments disclosed herein. The embodiments of the present invention are presented to enable any person of ordinary skill in the art to make and practice the present invention. The shapes of elements shown in the drawings are illustrated to describe the principles, basic structures, and general operation and functions of the present invention.

Referring to the drawings, basic structures, general concepts, and operations of the rotary machine of the present invention are described herein. The disclosure may be achieved in various different forms without being limited to the embodiments set forth herein. For clarity of description, like numerals refer to like elements throughout. It is further noted that at least some of the drawings are shown in schematic illustration, and they may include exaggerated views that are not shown in scale.

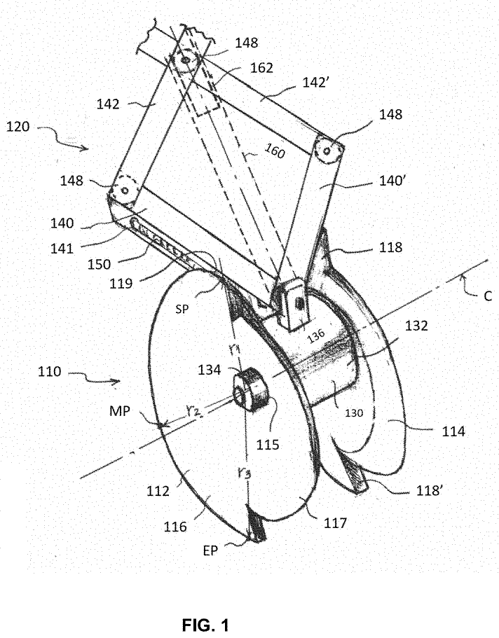

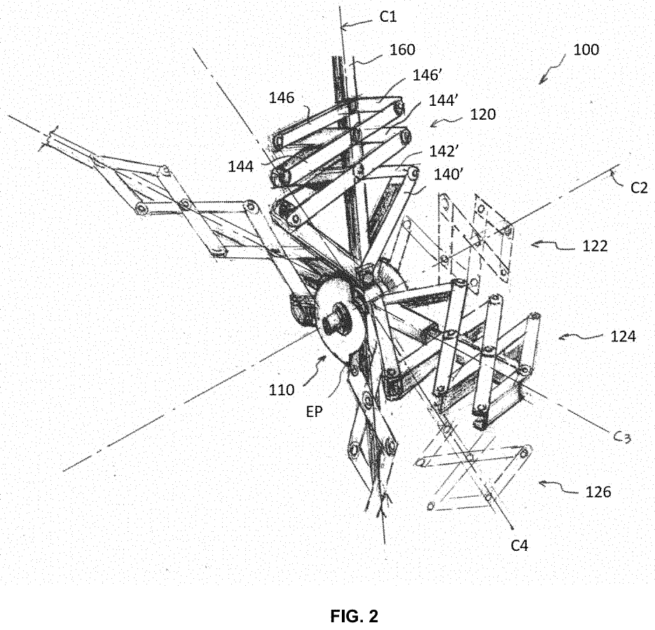

Referring first to FIGS. 1 and 2, rotary machine 100 includes cam shaft 110 coupled to a plurality of linkage shafts (e.g., 120, 122, 124, 126) arranged in radial direction around the cam shaft 110 in an alternately shifting manner to be described below.

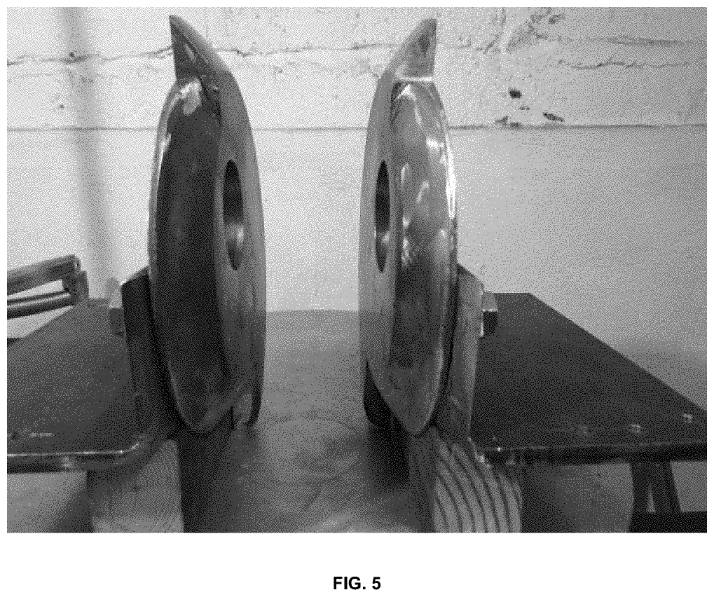

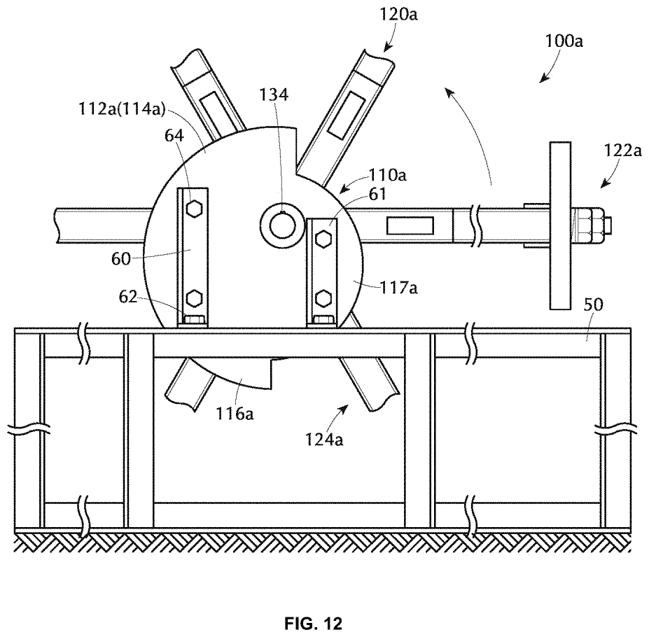

The cam shaft 110 includes a pair of arc-shaped cam members 112, 114 of identical shape affixed in parallel to a frame, such as flange members as shown in FIG. 5 (and FIG. 12), or other known fixing structures to securely hold the cam members in stationary position. Each cam member 112/114 includes a cam contact portion 116 of relatively enlarged arc/curvature shape covering about one half (about 180 degree) of the outer circumference of the cam member 112/114, and a non-cam-contacting portion 117 of reduced curve shape covering the remaining circumference of the cam member 112/114, thus, providing two opposing stepped areas 118 and 118′ in the boundary areas between the cam contact portion 116 and the non-contacting portion 117.

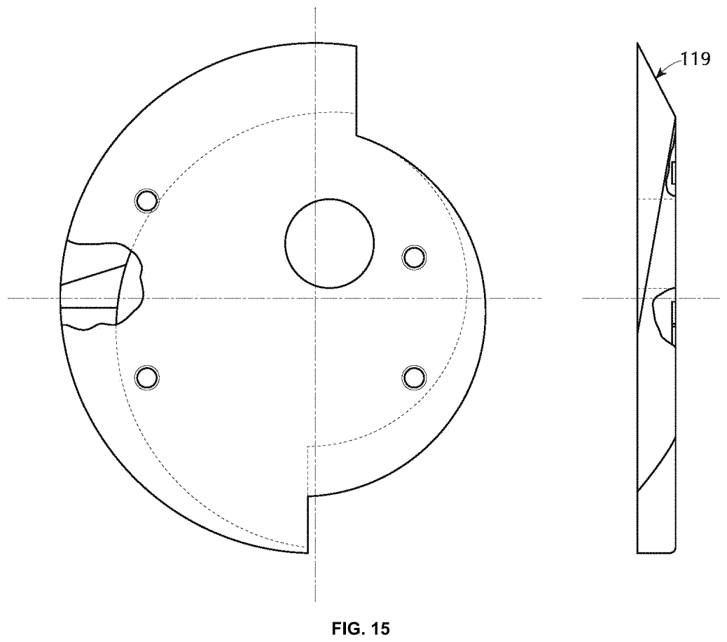

Both of the cam contact portions 116 and the non-contacting portions 117 can have a circular, elliptical, parabolic, or other curved shape, and each cam contact portion 116 includes an angled contact surface 119 (see also FIG. 15) to which the low-friction bearings, such as roller bearings (to be described below), retained in the linkage shafts (e.g., 120, 122, 124, 126) are contacting in the manner to be described below.

The cam members 112 and 114 each include a shaft coupling hole 115 formed in the center axis “C” of rotational components of the rotary machine 100 including the linkage shafts (e.g., 120, 122, 124, 126). In one preferred embodiment, the center of the shaft coupling hole 115 is not located at a center of the circular or arced contour of the cam contact portions 116, but at an eccentric location of the circular/arced contour of the cam contact portions 116 (see FIGS. 12 and 15 for details). In this manner, the radial distance from the center axis “C” to the arced surface is configured to be gradually increased from a contact starting point “SP” to a contact end point “EP” of the cam contact portion 116. Thus, the radial distance of the contact surface of the cam contact portion 116 from the center axis “C” has the minimum value (r1) at the contact starting point “SP”, and gradually increases and becomes the medium value (r2) at an intermediate point “MP”, and becomes the maximum value (r3) at the contact end point “EP”.

According to the above embodiment as shown, the surface contour of the cam contact portions 116 is preferably of circular shape of constant radius with the rotational center of the cam member located at an eccentric position as described above (see FIG. 15 in detail). However, the present invention is not limited to this cam configuration. For example, it is further envisioned that the surface contour of the cam contact portions 116 can be of non-circular shape of constant radius, but it can be elliptical, parabolic, and/or other curved shape as long as it can cause the corresponding linkage shafts (e.g., 120, 122, 124, 126) contacting the inner cam contact portions 116 to progressively reduce its link width while enlarging its axial linkage length upon rotation of the rotor shaft 130, which is to be describe in detail below.

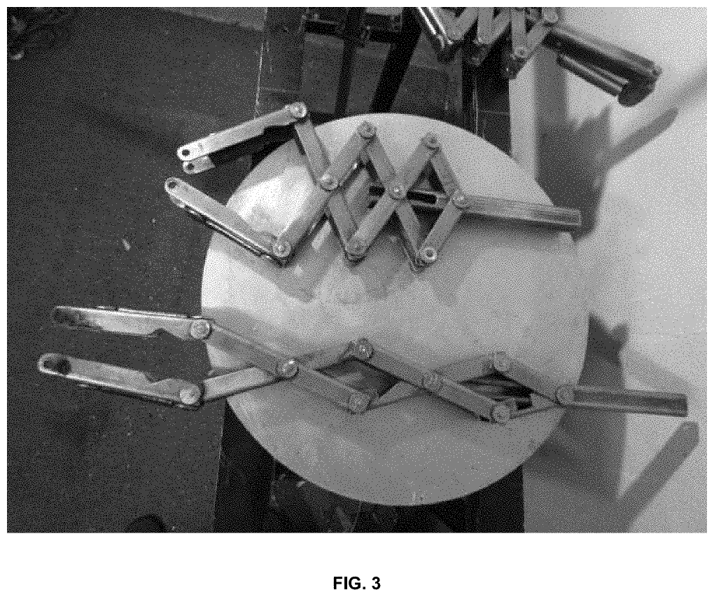

Referring again to FIGS. 1 and 2, the cam shaft 110 preferably further includes a rotor shaft 130 disposed rotatably in the center axis “C” of the machine between the two opposing cam members 112 and 114 in a rotatable manner relative to the stationary cam members 112 and 114. The rotor shaft 130 includes a main shaft portion 132 to which multiple sets of opposing parallel hinge members 136 are affixed, and a terminal end portion 134 of reduced diameter which is rotatably coupled to the shaft coupling hole 115 of the cam members 112 and 114, preferably with ball or roller bearing engaged there-between to minimize rotational friction between the components. The linkage shafts (e.g., 120, 122, 124, 126) each include a set of first (base) linkage members 140 and 140′, a set of second linkage members 142 and 142′, a set of third linkage members 144 and 144′, and a set of fourth linkage members 146 and 146′. One example of the linkage shafts is shown in FIG. 3 for illustration.

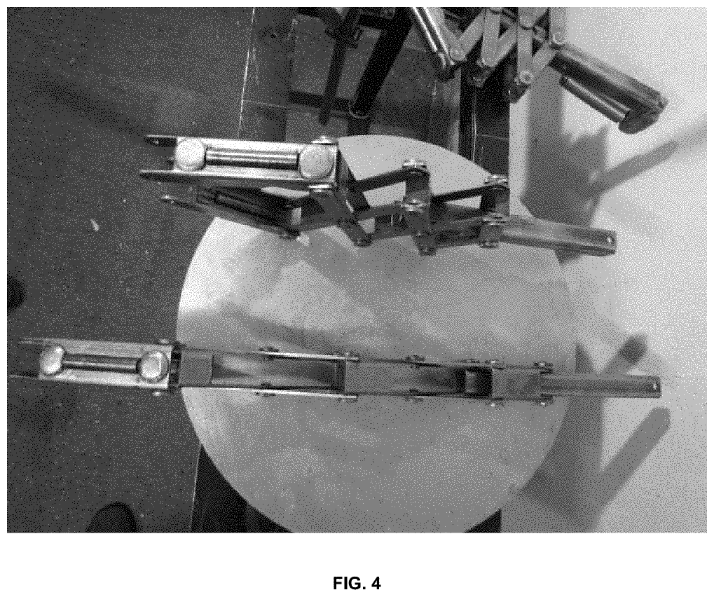

The proximal ends of the first linkage members 140 and 140′ are pivotally coupled to the opposing hinge members 136, and the second to fourth sets of the linkage members (142/142′, 144/144′ and 146/146′) are pivotally coupled to one another via pivot pins 148. The first (base) linkage members 140 and 140′ include bearing reception grooves 141 to which low-frictional bearings (e.g., roller bearings) 150 are retained in order to provide smooth and low-frictional contacts between the first linkage members 140, 140′ and the cam contact portions 116 of the parallel cam members 112 and 114. One example of the roller bearings retained in the first linkage shaft member is shown in FIG. 4 for illustration.

Each of the linkage shafts (e.g., 120, 122, 124, 126) may optionally include a guide shaft 160 placed along the center axis line (e.g., C1, C2, C3, and C4) of the linkage shafts to guide the axial movement of the linkage shafts. In order to facilitate the linear movement, each linkage shaft (e.g., 120, 122, 124, 126) may further include a guide hole 162 (see FIGS. 1 and 3) to which the pivot pins 148 centrally located in the second to fourth linkage shafts (122, 124, 126) are positioned to facilitate the linear guidance.

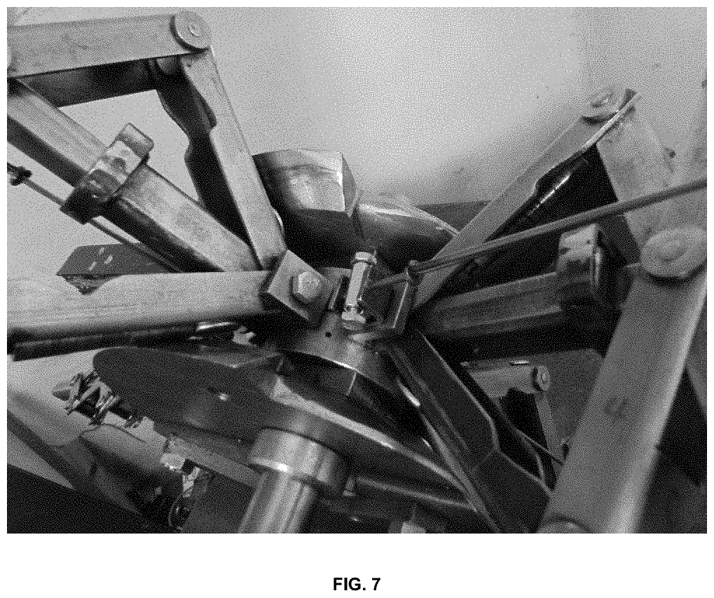

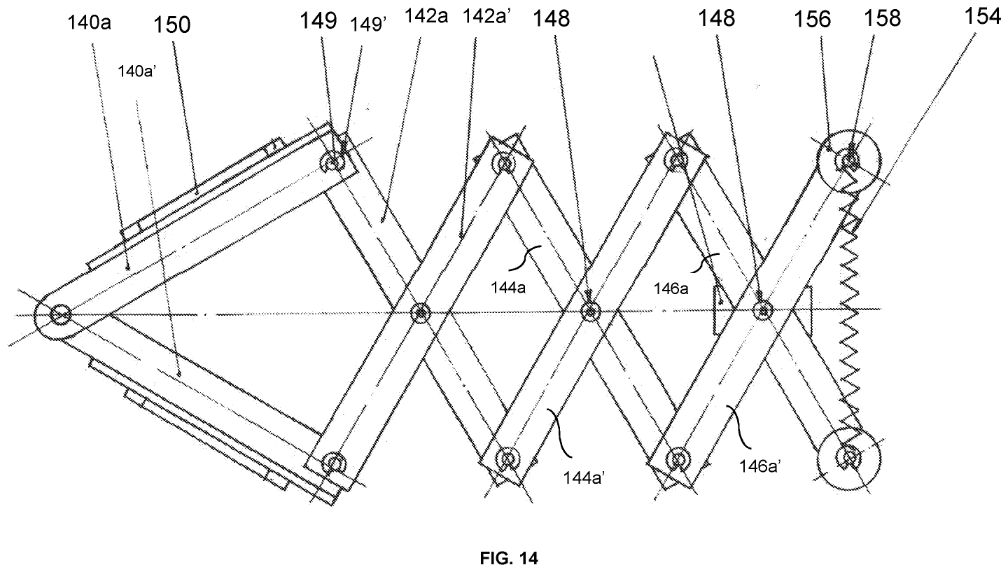

Each of the linkage shafts (e.g., 120, 122, 124, 126) may optionally include a coil spring to facilitate a smooth operation of the linkage shafts. Examples of the coil spring are shown in FIGS. 7, 10A, 10B, 10C, and 11. However, the invention is not limited to these disclosed structures, and the spring can be placed in other parts or other locations of the linkage shafts (e.g., 120, 122, 124, 126), for example, in a manner as shown in FIG. 14 (i.e., spring 154) which will be described below.

As explained above, the radial distance of the contact surface of the cam contact portion 116 from the center axis “C”, has the minimum value (r1) at or adjacent the contact starting point “SP” which is adjacent to the top point of the cam member, and gradually increases and becomes the medium value (r2) at/adjacent the middle point “MP”, and becomes the maximum value (r3) at/adjacent the contact end point “EP” which is adjacent to the lowest point of the cam member, thus generating a down stroke empowering cycle owing to the gravity of the linkage shaft which enlarges its axial length as described above as well as the rotational centrifugal force of the linkage shaft.

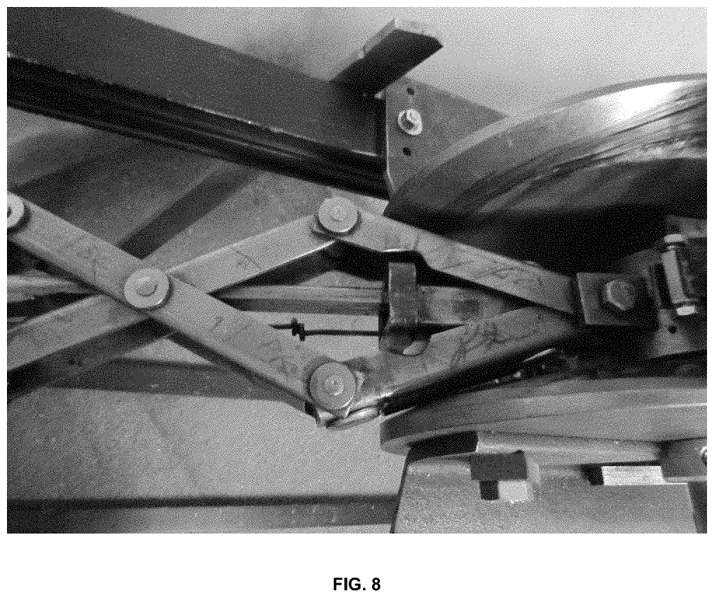

As such, the combination of the cam contact configuration and the progressive length changing configuration of each linkage shaft causes a first half (the upper half shown in FIGS. 1 and 2) of the first linkage shaft 120 to perform: (1) a first half cycle of a progressive length-enlarging movement of the first linkage shaft from the shortest length state (i.e., shortened linkage state) when the linkage shaft is located at/adjacent the contact starting point “SP” as shown in FIG. 1 (see also FIG. 7), to the longest length state (i.e., enlarged linkage state) when the linkage shaft is located at/adjacent the contact ending point “EP” (see also FIG. 8); and (2) a second half cycle of a progressive length-reducing movement of the first linkage shaft from the longest length state (i.e., enlarged linkage state) when the linkage shaft is located at/adjacent the contact ending point “EP”, to the shortest length state (i.e., shortened linkage state) when the linkage shaft is located at/adjacent the contact starting point “SP” (see also FIG. 8), while in this cycle the opposite side (the second half) of the first linkage shaft 120 is performing the above-described first half cycle of the progressive length-enlarging movement empowering the rotational force due to (see also FIG. 12 for easier understanding).

Here, as the linkage shaft turns continuously (counterclockwise in FIGS. 1 and 2), the center of gravity of the shaft (and thus, the centrifugal force of the shaft) shifts back and forth repeatedly. As result, the first linkage shaft 120 can turn continuously while overcoming the frictions in the moving components of the machine. The above analysis can be applied same in connection with all of the linkage shafts (e.g., 120, 122, 124, 126). As such, the rotary machine of the present invention resembles an ideal motion device that can rotate with greater power efficiency while overcoming or cancelling the frictions existing in the mechanical components of the apparatus.

Now, other drawings are explained below in detail with reference to the drawings illustrating photographic representations according to one exemplary embodiment of the present invention.

FIG. 7 illustrates the operation of the linkage mechanism coupled to the cam shaft of the rotary machine, in particular, shows an operation state of the machine, namely, a shortened linkage state in which two adjacent linkage shafts rotating counterclockwise are shown to be in the vicinity of the starting point of the cam contact zone, with the linkage shaft shortened in overall length.

Here, the first linkage shaft (i.e., the left shaft in the drawing) and the second linkage shaft (the right shaft) are shown to be rotating in counterclockwise direction, and the first linkage shaft is shown to be in a shortened linkage state and in the position just entered the cam contact zone of the cam members, thus, in cam contact with the enlarged cam contact surface of the cam members. Here, the second linkage shaft (the right shaft which is idle) is in the position approaching to the cam contact surface, and also in the shortened linkage state.

FIG. 8 is a photographic view for illustrating the general concepts and base operation of the linkage mechanism coupled to the cam shaft of the rotary machine, in particular, depicting an operation state (that is, an enlarged linkage state) of the machine, which is subsequent to the state shown in FIG. 7, in which the first linkage shaft (the left one in FIG. 7) rotating counterclockwise is located a distance away from the starting point of the cam contact zone, and relatively enlarged in the lengthwise direction while in contact with the cam surfaces of the cam shaft;

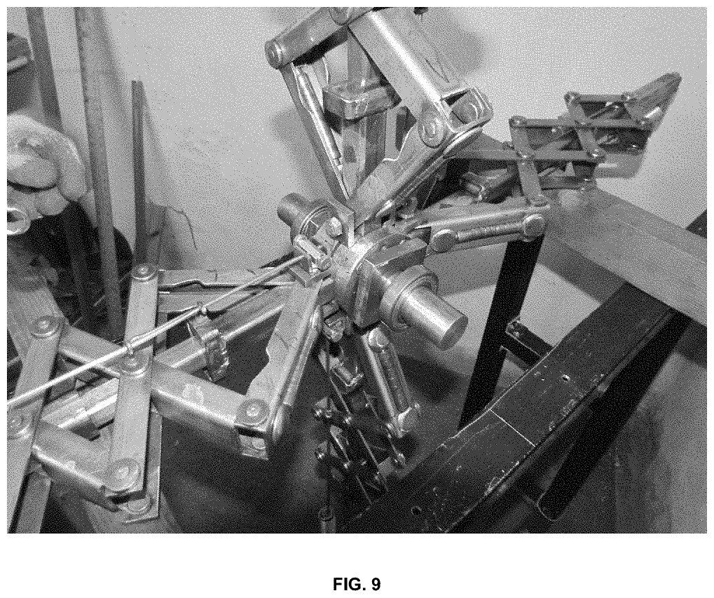

FIG. 9 is a photographic view for illustrating basic operations of the linkage mechanism of the rotary machine (shown in the form of a mockup/prototype sample) having two linkage shafts, where the cam members of the cam shaft are dissembled from the apparatus for simplicity purposes and in order to show the actual shapes of two linkage shafts in full detail. This drawing also shows that the shortened linkage state and the enlarged linkage state can be alternately shifted in one linkage shaft, namely, the first shaft having a relatively shortened state at the upper haft and a relatively lengthened state at the lower half, and the second shaft having a relatively shortened state at the left haft and a relatively lengthened state at the right half.

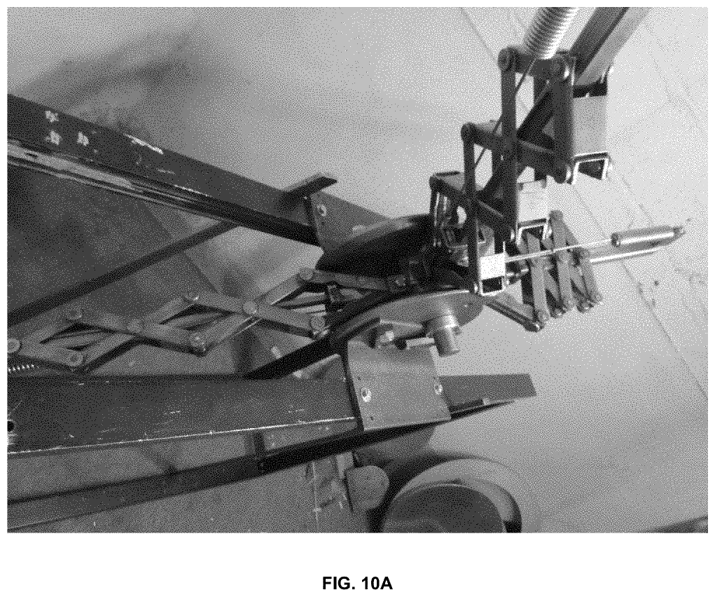

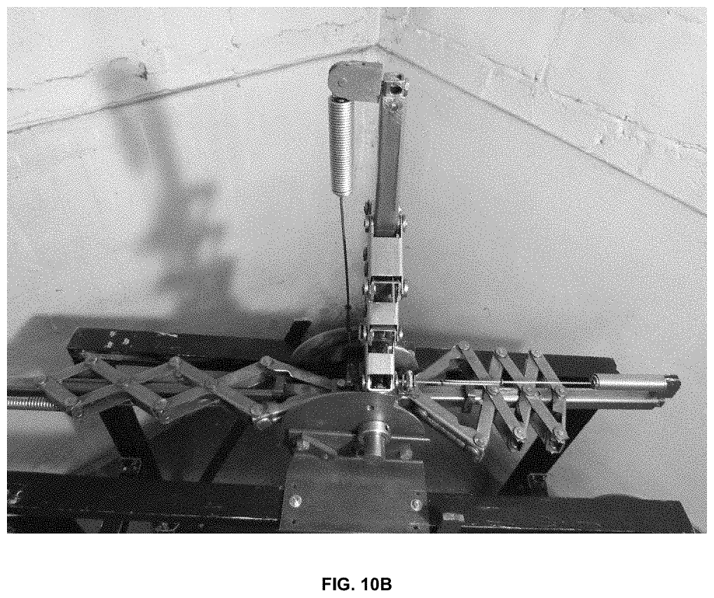

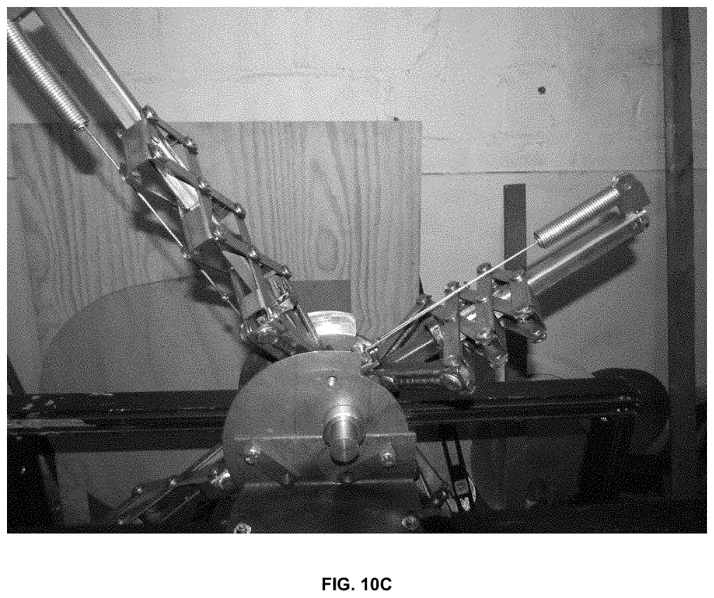

FIGS. 10A, 10B and 10C are other photographic views for illustrating basic operations of the linkage mechanism coupled to the cam shaft of the rotary machine shown in the form of a mockup/prototype sample.

In these photographic drawings, a state of the machine having two linkage shafts is illustrated for example, in which the first half (shown in the right side in the drawings) of the first linkage shaft and the first half (shown in the upper side) of the second linkage shaft, both of which located in the vicinity of, and approaching to, the starting point of the cam contact zone are in a shortened linkage state (similar to that shown in FIG. 7), while the second half (shown in the left side) of the first linkage shaft and the second half (hidden in the lower side) of the second linkage shaft, both of which located away from the starting point of the cam contact zone (thus, in the vicinity of the ending point of the cam contact zone) are in an enlarged linkage state. Here, the centers of gravity (and the centrifugal force) of the second half sides of the two linkage shaft become greater than that of the first half sides, and the continuous shifting movements of the shafts can empower the machine significantly and overcome the frictions associated in the operating components of the machine.

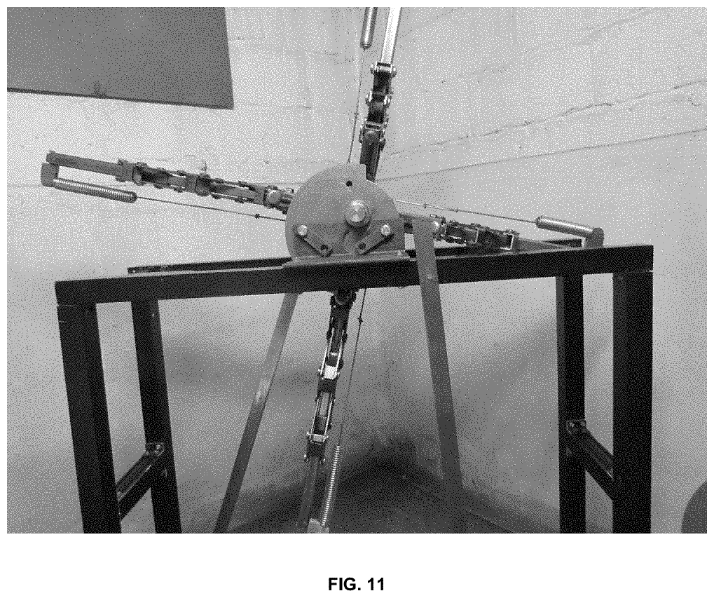

FIG. 11 is a photographic view similar to FIGS. 10A to 10C, illustrating the basic operation and full details of the linkage mechanism of the rotary machine shown in the form of a mockup/prototype sample, having two linkage shafts for example. This picture similarly depicts the alternating/shifting linkage mechanism of the machine, continuously shifting from the shortest linkage state (the upper half of the first linkage shaft), gradually enlarging to an intermediate linkage state (the left half of the second linkage shaft), and to the longest linkage state (the lower half of the first linkage shaft), and reducing gradually back to an intermediate linkage state (the right half of the second linkage shaft), and to the shortest linkage state (the upper half of the first linkage shaft).

As shown above in connection with FIGS. 9-11, the exemplary embodiments of the rotary machine illustrated in this disclosure are provided mostly in the form having two (2) linkage shafts spaced equally apart from each other, each linkage shaft composed of two shaft portions extending in a radially opposite direction from the center of the rotary machine and the rotor shaft 130. However, the present invention is not limited thereto, and the rotary machine can have different configurations. For example, the rotary machine can have three (3) or more linkage shafts spaced equally apart from one another, each linkage shaft composed of two shaft portions extending in a radially opposite direction from the center of the rotary machine and the rotor shaft 130, for example, as shown in FIGS. 12-15 to be described below.

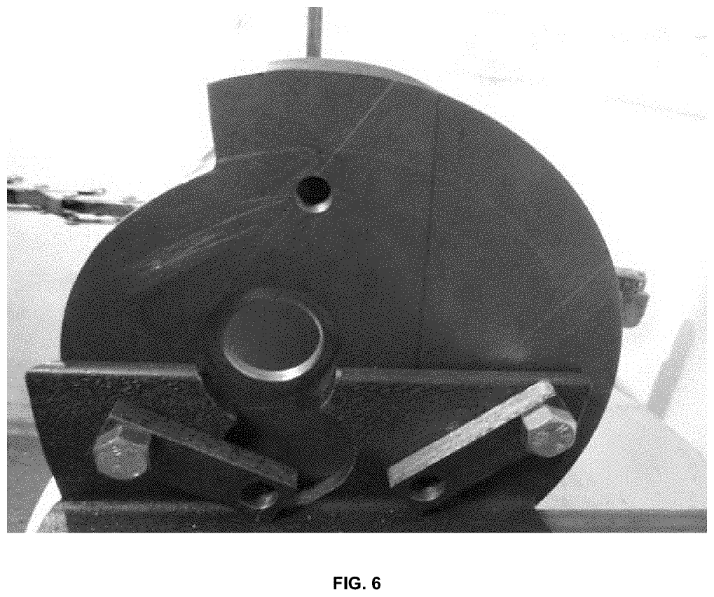

Referring now to FIGS. 12-15, another preferred embodiment of the rotary machine is described herein below. The basic structure of this rotary machine is basically same or similar to those described above and shown in association with FIGS. 1-11, and unless specifically discussed below, detailed descriptions regarding to various common elements and structures of this embodiment are to be omitted herein for simplicity purposes, and to be referred above.

Rotary machine 100a of the present embodiment includes cam shaft 110a coupled to a plurality of linkage shafts arranged in radial direction around the cam shaft 11010a in an alternately shifting manner similar to the previous embodiments discussed above.

The cam shaft 110 includes a pair of arc-shaped cam members 112a, 114a of symmetrical shape affixed to a frame 50 of suitable size, preferably formed with panels and structural members as shown and including fixing structures (e.g., fixing flange 60, 61 and fasteners 62, 64) to securely hold the cam members in stationary position. Each cam member 112a/114a includes a cam contact portion 116a of relatively enlarged arc/curvature shape covering about one half (about 180 degree) of the outer circumference of the cam member, and a non-cam-contacting portion 117a of reduced curve shape covering the remaining circumference of the cam member, thus, providing two opposing stepped areas 118 and 118′ in the boundary areas between the cam contact portion 116a and the non-contacting portion 117a.

The cam contact portions 116a and the non-contacting portions 117a can have a circular, elliptical, parabolic, or other curved shape, and each cam contact portion 116 includes an angled contact surface 119 to which the low-friction bearings, such as roller bearings, retained in the linkage shafts (e.g., 120a, 122a, 124a) are contacting in the manner described above.

FIG. 15 illustrates the shape and dimension of the cam members 112a and 114a according to one preferred embodiment. In this embodiment, the center of the shaft coupling hole 115 is not located at the center of the arced/curved contour of the cam contact portions 116a, but at an eccentric location of the arced/curved contour of the cam contact portions 116a. In this manner, the radial distance from the center axis “C” of the machine to the arced/curved surface is configured to be gradually increased from the contact starting point “SP” to the contact end point “EP” of the cam contact portion 116 in the manner described above in connection with FIGS. 1 and 2.

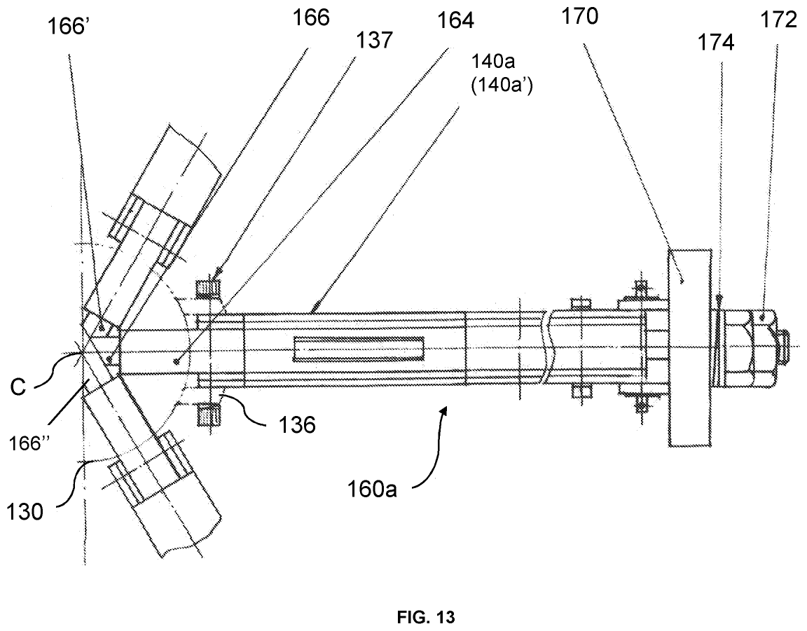

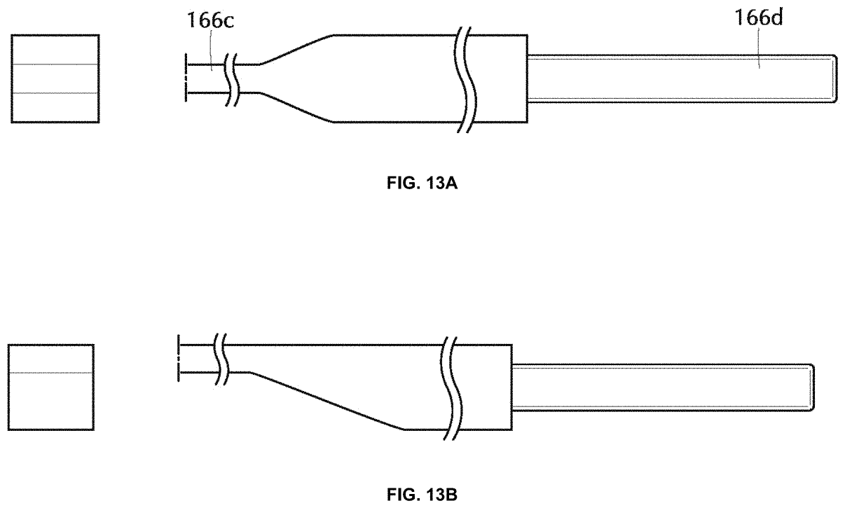

The rotary machine includes a rotor shaft 130 (see FIGS. 1 and 13) disposed rotatably in the center axis “C” of the machine between the two opposing cam members 112a and 114a in a rotatable manner relative to the stationary cam members 112a and 114a. In this embodiment, the rotary machine 100a has three linkage shafts 120a, 122a, and 124a, and each linkage shaft includes a set of first (base) linkage members 140a and 140a′, a set of second linkage members 142a and 142a′, a set of third linkage members 144a and 144a′, and a set of fourth linkage members 146a and 146a′, as illustrated in FIG. 14. The linkage shafts may preferably include one or a pair of spring 154 coupled to the end linkage members (or the fourth linkage members 146a and 146a′ in this embodiment) to facilitate a smooth operation of the linkage shafts in connection with the cam members. The linkage shafts may also include follower rings 156 and coupling washers 158 coupled to the linkage members.

The proximal ends of the first linkage members 140a and 140a′ are pivotally coupled to the opposing hinge members 136 (see FIGS. 1 and 13) via pivot pin 137, and the second to fourth sets of the linkage members (142a/142a′, 144a/144a′ and 146a/146a′) are pivotally coupled to one another via pivot pins 148/149. The first (base) linkage members 140a and 140a′ include bearing reception grooves to which low-frictional bearings (e.g., roller bearings) 150 are retained in order to provide smooth and low-frictional contacts between the first linkage members 140a, 140aa′ and the cam contact portions 116 of the parallel cam members 112a and 114a.

As illustrated in FIG. 13, each of the linkage shafts 120a, 122a, and 124a preferably includes a guide shaft 160a placed along the center axis line of the linkage shafts (in particular, placed between two opposing components of linkage shafts) to guide the axial movement of the linkage shafts. In order to facilitate the linear movement, each linkage shaft (e.g., 120a, 122a, 124a) may further include a guide hole 162 (see FIGS. 1 and 3) to which the central pivot pins 148 centrally located in the second to fourth linkage shafts (122a, 124a, 126a) are positioned to facilitate the linear guidance.

Each guide shaft 160a preferably includes a fixed pipe/tube member 164 affixed to the rotor shaft 130 (see also FIG. 1) and rotating together with the rotor shaft, and reciprocating bar 166 slidable passing through the inner through hole of the fixed pipe/tube member 164 and also through the center axis “C” of the machine. In this embodiment, the fixed pipe/tube member 164 has the inner through hole of square cross-section, each side of the hole having a hole thickness “t”, and a central portion (166c) of the reciprocating bar 166, 166′, 166″ has a thickness of approximately “t/3”, as shown in FIGS. 13, 13A and 13B for example, in which FIG. 13A represents the reciprocating bar 166 for the first linkage shaft 120a, and FIG. 13B represents the reciprocating bar 166′ for the second linkage shaft 122a, and the reciprocating bar 166″ for the third linkage shaft 124a is the mirror image of the second reciprocating bar 166′. In this manner, the reciprocating bars 166, 166′, 166″ of the three linkage shafts 120a, 122a, and 124a do not interfere with one another as they slidably pass through its corresponding fixed pipe/tube member 164 and the center axis “C” of the machine.

In addition, each linkage shaft (e.g., 120a, 122a, 124a) may further include a weight member 170 coupled to a distal end 166d of each reciprocating bars (166, 166′, 166′) with the aid of suitable fixing elements such as double bolts 172 and washer 174. It is noted that the dimensions shown in the drawings are for illustrative purposes in accordance to one exemplary embodiment of the invention.

Even though it is not shown in this disclosure, the rotary machine of the invention can have three or more linkage shafts spaced equally apart from one another, wherein each of the linkage shafts are not composed of two shaft portions extending in a radially opposite direction from the center of the rotary machine (as discussed above), but such linkage shafts can be composed of one radially-extending shaft portion extending only in one radially outward direction from the center of the rotary machine. For instance, the rotary machine can have five (5) radially-extending shaft portions spaced equally apart from one another at 72 degree interval. For another instance, the rotary machine can have seven (7) radially-extending shaft portions spaced equally apart from one another at 51.43 degree interval, or nine (9) radially-extending shaft portions spaced equally apart from one another at 40 degree interval.

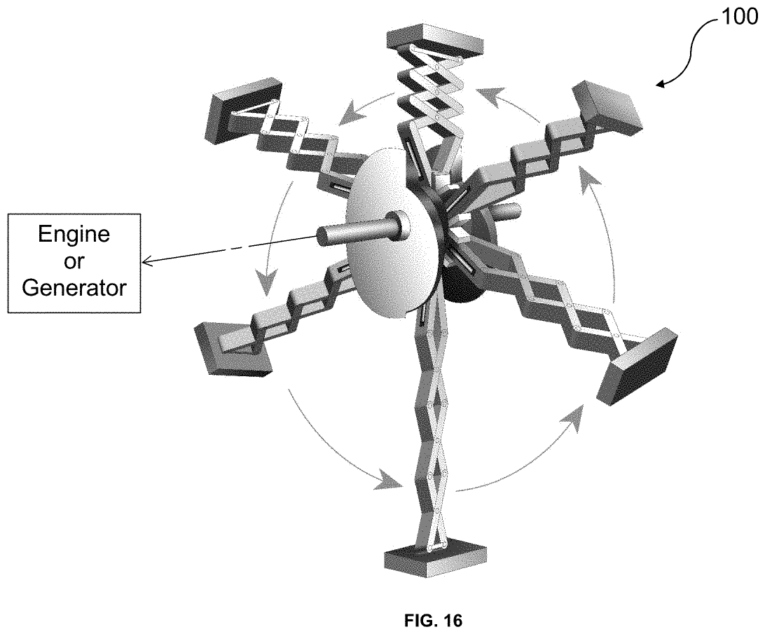

As detailed above, the rotary machine of the present invention resembles an ideal motion device that can rotate with greater power efficiency while overcoming or cancelling the frictions existing in the mechanical components of the apparatus. The rotary machine can be utilized in a wide variety of manners for utility purposes. For example, as illustrated in FIG. 16, the rotary machine can be used as or modified to an engine utilizing the rotational force of the rotor shaft 130, for example, to rotate the wheels of a vehicle in a manner readily recognizable by persons skilled in the art. For another example, the rotary machine can be used as or modified to a generator which utilizes the rotational force of the rotor shaft 130 to convert the rotational energy into an electrical energy in a manner well known in the generator technologies.

Although the currently preferred embodiments of the present invention have been disclosed for illustrative purposes, those skilled in the art will appreciate that various modifications, additions and substitutions are possible, without departing from the scope and spirit of the invention as will be understood by those skilled in the art upon examining the full disclosure in association with the drawings provided.

What is claimed is:

1. A rotary machine comprising:
a cam shaft;
a rotor shaft; and
a plurality of linkage shafts affixed to the rotor shaft and operably coupled to the cam shaft, each of the linkage shafts including a pair of first linkage members adapted for cam contact with the cam shaft, a pair of second linkage members pivotally coupled to the first linkage members, and a pair of third linkage members pivotally coupled to the second linkage members,
wherein each of the linkage shafts is progressively and continuously changing between a shortest linkage state having a shortest axial length and a longest linkage state having a longest axial length due to the cam contact between the cam shaft and the linkage shafts, upon rotation of the linkage shafts about the cam shaft.

2. The rotary machine according to claim 1, wherein the cam shaft comprises a pair of stationary cam members, each cam member having a cam contact portion of relatively enlarged curve shape covering about one half of an outer circumference of the cam member, and a non-contacting portion of reduced curve shape covering the remaining circumference of the cam member.

3. The rotary machine according to claim 2, wherein a radial distance from a center axis to the curved cam contact surface of each cam member is configured to be gradually increased from a contact starting point to a contact end point of the cam contact portion.

4. The rotary machine according to claim 2, wherein the cam contact surface of the pair of cam members include angled contact surfaces facing toward each other, to which surfaces a base portion of the linkage shafts contact upon rotation of the linkage shafts.

5. The rotary machine according to claim 2, wherein the cam contact surface of each cam member has a circular contour of constant radius with its center eccentrically located from a center of the circular cam contact surface of the cam member.

6. The rotary machine according to claim 2, wherein the cam contact surface of each cam member has an elliptical, parabolic, or curved shape other than a circular shape of constant radius.

7. The rotary machine according to claim 1, wherein each of the linkage shafts further includes a pair of fourth linkage members pivotally coupled to the third linkage members.

8. The rotary machine according to claim 1, further comprising at least one bearing retained in the first linkage members at an area for the cam contact with the cam shaft.

9. The rotary machine according to claim 1, further comprising a coil spring coupled to each of the linkage shafts for smooth operation.

10. The rotary machine according to claim 1, further comprising a guide shaft positioned along a center axis line of each of the linkage shafts to guide the axial movement of each linkage shaft.

11. The rotary machine according to claim 10, wherein the guide shaft includes a guide hole adapted to receive central pivot pins centrally located in the second and third linkage shafts to facilitate the axial guidance of each linkage shaft.

12. The rotary machine according to claim 10, wherein the guide shaft includes a fixed guide member affixed to the rotor shaft and rotating together with the rotor shaft, and a reciprocating guide member slidable passing through an inner through hole of the fixed guide member and also through a center axis of the machine.

13. The rotary machine according to claim 12, wherein the fixed guide member has the inner through hole of a square-shaped, and the reciprocating guide member has a bar shaped portion with a thickness approximately one third of the dimension of the square-shaped inner through hole.

14. The rotary machine according to claim 12, further comprising a weight member coupled to a distal end of the reciprocating guide member.

15. An engine comprising:
a cam shaft;
a rotor shaft; and
a plurality of linkage shafts affixed to the rotor shaft and operably coupled to the cam shaft, each of the linkage shafts including a pair of first linkage members adapted for cam contact with the cam shaft, a pair of second linkage members pivotally coupled to the first linkage members, and a pair of third linkage members pivotally coupled to the second linkage members,
wherein each of the linkage shafts is progressively and continuously changing between a shortest linkage state having a shortest axial length and a longest linkage state having a longest axial length due to the cam contact between the cam shaft and the linkage shafts, upon rotation of the rotor shaft and the linkage shafts about the cam shaft,
wherein the cam shaft comprises a pair of stationary cam members, each cam member having a cam contact portion of relatively enlarged curve shape covering about one half of an outer circumference of the cam member, and a non-contacting portion of reduced curve shape covering the remaining circumference of the cam member.

16. A generator comprising:
a cam shaft;
a rotor shaft; and
a plurality of linkage shafts affixed to the rotor shaft and operably coupled to the cam shaft, each of the linkage shafts including a pair of first linkage members adapted for cam contact with the cam shaft, a pair of second linkage members pivotally coupled to the first linkage members, and a pair of third linkage members pivotally coupled to the second linkage members,
wherein each of the linkage shafts is progressively and continuously changing between a shortest linkage state having a shortest axial length and a longest linkage state having a longest axial length due to the cam contact between the cam shaft and the linkage shafts, upon rotation of the rotor shaft and the linkage shafts about the cam shaft,
wherein the cam shaft comprises a pair of stationary cam members, each cam member having a cam contact portion of relatively enlarged curve shape covering about one half of an outer circumference of the cam member, and a non-contacting portion of reduced curve shape covering the remaining circumference of the cam member.
